(19) United States
(12) Patent Application Publication
(10) Pub. No.: US 2013/0157833 A1
(43) Pub. Date: Jun. 20, 2013

(54) CLEANING APPARATUS FOR GAS SCRUBBER FLUID

(71) Applicants: Staffan Königsson, Tumba (SE); Lena Sundquist, Stockholm (SE)

(72) Inventors: Staffan Königsson, Tumba (SE); Lena Sundquist, Stockholm (SE)

(73) Assignee: ALFA LAVAL CORPORATE AB, Lund (SE)

(21) Appl. No.: 13/807,151

(22) PCT Filed: Jun. 15, 2011
(86) PCT No.: PCT/EP11/59920

§ 371 Date: Mar. 8, 2013

(30) Foreign Application Priority Data
Jul. 2, 2010 (SE) 10168279.7

(51) Int. Cl. B01D 19/00

(52) U.S. Cl. CPC B01D 19/0057
USPC 494/5; 494/67; 494/53; 494/23; 494/1; 494/37

(57) ABSTRACT

A cleaning apparatus for polluted scrubber fluid from an exhaust gas scrubber fluid loop includes means for bleeding off part of the polluted scrubber fluid from the scrubber fluid loop, a disc stack centrifugal separator for separating a pollutant phase and a cleaned scrubber fluid from said part. The separator includes a rotor enclosing a separation space with a stack of separating discs, a separator inlet extends into the separating space, a first separator outlet for cleaned scrubber fluid extending from said separating space, and a second separator outlet for the pollutant phase extending from the separating space. The cleaning apparatus includes means for conducting the part to the separator inlet, and means for discharging the cleaned scrubber fluid from the first separator outlet, and means for collecting the pollutant phase from the second separator outlet.

### TECHNICAL FIELD

The present invention relates to a cleaning apparatus for gas scrubber fluid and to the use of a disc stack centrifugal separator in such a cleaning apparatus.

### BACKGROUND OF THE INVENTION

The shipping industry of today strives to reduce harmful emissions, such as emissions originating from the combustion of fuel in the engines, in order to minimize the negative environmental impact and fulfil present and upcoming emission regulations, such as regulations set up by the International Maritime Organization (IMO).

One object of the emissions regulations is the reduction in sulphuric oxide (SO_{X}) emissions from ships. Sulphuric oxides are created in the combustion of fuels containing sulphuric residues. The amount of sulphuric oxides in exhaust gas can be reduced by exhaust gas cleaning, e.g. by using scrubbers. The process of cleaning exhaust gas with the aid of the mentioned scrubbers produces polluted scrubber fluid.

Another object of the emissions regulations is the reductions in nitrogen oxides (NO_{X}) emissions from marine engines. This can be done by implementing Exhaust Gas Recirculation (EGR), where part of the exhaust gas is recirculated to the combustion chamber of the engine. However, the amount of soot and particles in the exhaust gas needs to be decreased. It is therefore desirable to clean the exhaust gas, which can be done by using a scrubber. Also in this process, polluted scrubber fluid is produced.

The polluted scrubber fluid comprises soot or other organic or inorganic combustion residues. The release of such polluted scrubber fluid directly into the sea is unacceptable from an environmental point of view and is strictly regulated. On the other hand, it is expensive and undesirable to transport larger amounts of waste material to a harbour for disposal.

JP 3868352 B2 discloses equipment for wastewater treatment where polluted seawater from a scrubber is stored in a storage tank and then cleaned using a combination of a centrifugal separator and two oil filters before being recirculated to the scrubber.

During scrubbing of hot/warm exhaust gases by means of a wet scrubber, moisture in the exhaust gas may condensate into water, adding to the volume of scrubber fluid in the scrubber process. Further, various salts from the exhaust gas tend to be dissolved in the scrubber fluid in the scrubbing process. To reduce the risk of salt precipitates, the fluid may need to be diluted, whereby the volume of scrubber fluid increases.

Fluid may thus be added to the scrubber fluid loop from the exhaust gas and/or due to deliberate addition of fluid to the system. To maintain the volume of scrubber fluid in the system, scrubber fluid has to be bled off from the scrubber process. One problem is then to improve the cleaning of the scrubber fluid in order to be able to release the scrubber fluid into the environment with a minimal environmental impact. Another problem is the cleaning of the scrubber fluid in order to be able to fulfil regulations on the amount of polyaromatic hydrocarbons and turbidity in the scrubber fluid to be released into the environment.

### SUMMARY OF THE INVENTION

The present invention reduces the above mentioned shortcomings by further improving environmental aspects of exhaust treatment procedures, improving the efficiency in exhaust treatment procedures, minimizing the amount of waste material that needs to be handled and disposed and further minimizing the need for service and diminishing problems with process equipment handling scrubber fluid.

Thus, the present invention relates to a cleaning apparatus for polluted scrubber fluid from an exhaust gas scrubber fluid loop. The scrubber fluid loop may be a closed scrubber fluid loop, i.e. a circulation system providing recirculation of scrubber fluid through the scrubber and other components within the system. The scrubber fluid loop may include scrubbers used to clean the full flow of exhaust gas from an engine and/or scrubbers used to clean part of the flow of exhaust gas from an engine, e.g. during EGR. The cleaning apparatus comprises means for bleeding off part of the polluted scrubber fluid from the scrubber fluid loop, thereby removing the part of the polluted scrubber fluid from the scrubber fluid loop for disposal. The part of the polluted scrubber fluid being bled off from the scrubber fluid loop is preferably a small part of the flow of the fluid within the scrubber fluid loop. By recirculating the polluted scrubber fluid in the scrubber fluid loop through the scrubber and only bleeding off a small part of the polluted scrubber fluid from the scrubber fluid loop, the amount of pollutant phase in the polluted scrubber fluid can reach a level so as to to maintain efficient separation of the pollutant phase while minimizing the volume of polluted fluid that has to be treated.

The cleaning apparatus further comprises a disc stack centrifugal separator for separating at least a pollutant phase and a cleaned scrubber fluid from the part of the polluted scrubber fluid, which separator comprises a rotor, rotatably arranged around an axis of rotation, enclosing (i.e. forming within itself) a separation space with a stack of separating discs or a set of separating plates. The separating discs or plates may be frusto-conical or have any other suitable shape. The separator further comprises a separator inlet for said part of the polluted scrubber fluid extending into said separating space, a first separator outlet for cleaned scrubber fluid extending from said separating space, and a second separator outlet for the pollutant phase extending from said separating space. The first separator outlet preferably extends from a radially inner portion of the separating space with respect to the axis of rotation, and the second separator outlet preferably extends from a radially outer portion of the separating space. In one embodiment, the separator is further provided with a third separator outlet for another fluid phase which is denser or lighter than the scrubber fluid, such as oil.

In one embodiment, the cleaning apparatus includes two or more such disc stack centrifugal separators connected in parallel in order to provide an increased capacity allowing treatment of larger volumes of polluted scrubber fluid.

In one embodiment, the cleaning apparatus may further include means for conducting said part of the polluted scrubber fluid to the separator inlet, means for discharging the cleaned scrubber fluid from the first separator outlet, and means for collecting the pollutant phase from the second separator outlet. The means for conducting polluted and cleaned scrubber fluid and pollutant phase may comprise conduits, piping, tubing, tanks, pumps, valves and the like.

It has been found that, by using a disc stack centrifugal separator, the separation of the pollutant phase from exhaust gas scrubber fluid is surprisingly efficient. The cleaned scrubber fluid resulting from the operation of such a separator is thus able to fulfil regulations and can thus be released into the environment with a minimal environmental impact. The separation in such a separator is gentle enough to maintain particles agglomerated and at the same time efficient by providing high separation forces and short separating distances. It has also been found that lighter liquid organic residues in the scrubber fluid, such as oil particles, tend to adhere to denser solid particles in the fluid in a way that makes it possible, in the disc stack separator, to separate the oil and the solid particles as a pollutant phase which is denser than the scrubber fluid. Thus the cleaning apparatus does not have the same need for filters or other treatment steps and therefore improves the handling of the apparatus by minimizing the need for service and replacement of key components. It has also been proven that by applying a disc stack centrifugal separator on the scrubber fluid, a large part of the pollutant phase can be removed in concentrated form. Therefore the volume of waste material can also be kept low.

The rotor of the separator may further enclose a conveyor screw which is arranged to be driven at a rotational speed differing from the rotational speed of the rotor so that to convey the pollutant phase, i.e. a separated phase with density higher than the cleaned scrubber fluid, towards the second separator outlet. The second separator outlet may be provided on a smaller radius than the outer radius of the separating space, and the conveyor screw arranged to convey the pollutant phase radially inwards and towards the second separator outlet. The conveyor screw may be arranged to be driven at a rotational speed differing from the rotational speed of the rotor at least during a discharge operation of the separator. Non-limiting examples of such separators are described in WO9965610 and WO2008140378. The separator may be arranged to subject said part of the polluted scrubber fluid to a centrifugal force of at least 4000 G, preferably of at least 4500 G, more preferably of at least 5000 G during a fully developed operational speed, said centrifugal force being determined at an outer radius of the conveyor screw or at an outer radius of the separation space, in order to separate at least a pollutant phase and a cleaned scrubber fluid from said part of the polluted scrubber fluid. Due to this arrangement, the concentration of particles in the pollutant phase can be very high, thus minimizing the amount of waste material being produced, while still maintaining a cleaned scrubber fluid that is able to fulfil regulations and that can be released into the environment with a minimal environmental impact. The separator may be controlled to obtain a pollutant phase, wherein the concentration of particles is 20-65 weight percent (corresponding to approximately 45-95 volume percent).

As an alternative to being provided with a conveyor screw the separator may be an intermittently discharging separator wherein the second separator outlet comprises one or more discharge ports that may be opened during operation to intermittently discharge polluted phase from the separating space, or a nozzle separator, wherein the second separator outlet comprises one or more discharge nozzles for continuous discharge of polluted phase from the separating space. The discharge ports or discharge nozzles may preferably extend from an outer radius of the separating space to the outside of the rotor for discharge of a separated phase with density higher than the cleaned scrubber fluid, i.e. the pollutant phase. According to these alternatives, the amount of pollutant phase, i.e. solid and/or liquid particles, in the discharge may be within the range of from about 5 to about 45 volume percent, preferably from about 20 to about 30 volume percent, depending on discharge frequency or nozzle size. The cleaning apparatus may thus provide a large separation capacity from one such separator. According to a further alternative the cleaning apparatus may comprise means for conducting the pollutant phase from such an intermittently discharging separator or a nozzle separator to the inlet of a further disc stack centrifugal separator, which further separator comprises a rotor enclosing a separation space with a stack of separating discs or a set of separating plates. The separators may thus be connected in series. The further separator may comprise a conveyor screw arranged to be driven at a rotational speed differing from the rotational speed of the rotor, as previously described. According to this further alternative, the cleaning apparatus may provide a large separation capacity while still obtaining a pollutant phase wherein the concentration of particles is 20-65 weight percent (corresponding to approximately 45-95 volume percent) thus minimizing the amount of waste material being produced.

The separator inlet may be of a hermetic type. A hermetic inlet is sealed from the surroundings of the rotor and is arranged to be filled with scrubber fluid during operation. In a hermetic type of inlet the acceleration of the fluid is initiated at a small radius and gradually increased while the fluid leaves the inlet and enters the separation space. By using an inlet of a hermetic type, shear forces acting on the particle agglomerates in the scrubber fluid can be minimized, thereby improving the separation efficiency of the pollutant phase even further.

The means for conducting said part of the polluted scrubber fluid to the separator inlet may comprise a flow regulating device. The means for conducting said part of the polluted scrubber fluid to the separator inlet may further comprise a buffer tank for said part of the polluted scrubber fluid, arranged so that the separator inlet for said part of the polluted scrubber fluid is connected to the buffer tank via the flow regulating device. The flow regulating device may comprise a pump or a valve, such as a proportional valve etc.

The cleaning apparatus may further comprise means for adding a flocculant to said part of the polluted scrubber fluid upstream of the separator inlet. The flocculant facilitates agglomeration of particles in the polluted scrubber fluid and may be a polyelectrolyte.

The cleaning apparatus may further comprise means for adding a precipitant to said part of the polluted scrubber fluid upstream of the separator inlet. The precipitant preferably adds trivalent ions, such as trivalent iron or trivalent aluminium to the scrubber fluid and may comprise aluminium sulphate, (poly)aluminium chloride and/or iron chloride. Thereby dissolved salts may be precipited from the polluted scrubber fluid, further increasing the separation efficiency in the disc stack centrifugal separator.

The scrubber fluid may be water, but can also be other suitable liquids. Scrubber fluid as initially included in the process of cleaning exhaust gas, or as added to the process during operation, may preferably be tap water, fresh water or desalinated seawater. The scrubber fluid is in one aspect meant to be water having an amount of chlorides less than, or much less than sea water. Tap water can be provided from tanks or produced on board by desalination of seawater. The scrubber fluid may however contain salts included from the scrubber process. The term scrubber fluid can be meant to include cleaned, polluted scrubber fluid, scrubber fluid initially included in the process or added to the process, or combinations thereof. Cleaned scrubber fluid has a reduced amount of pollutants, but may still comprise a low amount of pollutants. The pollutant phase separated from the polluted scrubber fluid may still comprise a certain amount of scrubber fluid. The pollutant phase may comprise solid and/or liquid particles comprising organic or inorganic combustion residues such as sulphuric oxide residues, soot, partly oxidized and unoxidized diesel oil and salts from oxidized metals. The pollutant phase may be denser, i.e. having a higher density, than the cleaned scrubber fluid. Particles generated in the combustion in the engine are normally very small, below the μm scale and typically within the range of from about 10 to about 30 nm. In a suitable fluid such as water they agglomerate into clusters within the μm scale such as within the range from about 5 to about 100 μm, particularly within the range from about 10 to about 30 μm.

The cleaning apparatus may comprise means for controlling the quality of the cleaned scrubber fluid, and means for diverting and/or returning the cleaned scrubber fluid to the scrubber fluid loop, to the separator inlet or to a tank for polluted scrubber fluid if the quality is below a predetermined level. Thus the purity of the cleaned scrubber fluid can be further secured, minimizing the risk of potential negative environmental influence.

The cleaning apparatus may comprise means for bleeding off parts of the polluted scrubber fluid from more than one scrubber fluid loop and means for conducting said parts of the polluted scrubber fluid to the separator inlet.

Such scrubber fluid loops may include scrubbers used to clean the full flow of exhaust gas from an engine, and scrubbers used to clean part of the flow of exhaust gas from an engine e.g. during EGR. Such scrubber fluid loops may comprise further disc stack separators arranged to separating at least a pollutant phase and a cleaned scrubber fluid from said polluted scrubber fluid in the respective scrubber fluid loop. Non-limiting examples of such scrubber fluid loops are described in EP 10154682.8. The means for conducting said parts of the polluted scrubber fluid to the separator inlet may comprise flow regulating devices, so that to regulate the flow of the parts of the polluted scrubber fluid from each scrubber fluid loop to the separator inlet. Thereby the source or sources of polluted scrubber fluid may be controlled and regulated with respect to the capacity of the cleaning apparatus.

The means for conducting said part of the polluted scrubber fluid to the separator inlet may be arranged to receive polluted phase from a further disc stack centrifugal separator, which is included in the scrubber fluid loop and arranged to separating at least a pollutant phase and a cleaned scrubber fluid from said polluted scrubber fluid in the scrubber fluid loop. Thus the cleaning apparatus may be connected to a further disc stack centrifugal separator in a cleaning apparatus as described in EP 10154682.8. The means for conducting said part of the polluted scrubber fluid to the separator inlet may be arranged to receive polluted phase from a further disc stack centrifugal separator via a second buffer tank and at least one flow regulating element, such as a pump, a valve and the like.

The cleaning apparatus may comprise means for controlling and/or regulating the acidity of said part of the polluted scrubber fluid. The means for controlling and/or regulating the acidity may be arranged to keep the pH above 6, and may further be arranged to keep the pH below 8. The means for controlling and/or regulating the acidity may preferably be arranged to keep the pH within the range of 6-8. In one aspect, this may be done in order to compensate for acidic components, such as SO_{X}, in the exhaust gas which may cause the scrubber fluid pH to decrease. The acidity may be controlled and/or regulated by measuring and adjusting the pH, by adding a pH regulating compound such as NaOH (sodium hydroxide), CaO (calcium oxide) or Ca(OH)₂ (calcium hydroxide). The acidity of said part of the polluted scrubber fluid may be controlled and/or regulated in order to facilitate the precipitation of a certain amount of dissolved salts and thus to maintain good separation process in the disc stack separator.

The present invention also provides an exhaust gas cleaning apparatus for a diesel engine, such as a large engine on a ship, comprising a gas scrubber having an inlet for exhaust gas, a humidifying device for providing a scrubber fluid to the exhaust gas and a droplet separator for removing polluted scrubber fluid from the exhaust gas, a preferably closed scrubber fluid loop for circulating the scrubber fluid to the scrubber, connected to a cleaning apparatus according to the invention including means for bleeding off part of the polluted scrubber fluid from the scrubber fluid loop. The cleaning apparatus according to the invention is also applicable to similar land based scrubber installations for cleaning gas, such as exhaust gas.

In another aspect of the present invention, a method for cleaning polluted scrubber fluid from a scrubber fluid loop is provided, comprising the steps of;
bleeding off part of the polluted scrubber fluid from the scrubber fluid loop,
separating, in a disc stack centrifugal separator, at least a pollutant phase and a cleaned scrubber fluid from said part of the polluted scrubber fluid,
disposing the separated pollutant phase, and
discharging the cleaned scrubber fluid.

The method may further comprise the steps of controlling the quality of the cleaned scrubber fluid before discharging, and diverting the cleaned scrubber fluid if the quality is below a certain level. The cleaned scrubber fluid can be discharged into the environment, i.e. the sea, or stored in a tank for different purposes. The method is preferably performed by means of a cleaning apparatus as described above.

A further aspect of the present invention provides the use of a disc stack centrifugal separator to separate at least a pollutant phase and a cleaned scrubber fluid from polluted scrubber fluid being bled off from an exhaust gas scrubber fluid loop. The disc stack centrifugal separator may comprise a conveyor screw which is arranged to convey the pollutant phase towards a separator outlet for pollutant phase.

Further alternative embodiments of the present invention are defined in the claims. Various embodiments of the invention will now be explained in more detail with reference to the drawings. The drawings are for the purpose of illustrating the invention and are not intended to limit its scope.

### BRIEF DESCRIPTION OF THE DRAWINGS

FIG. 1 shows a cleaning apparatus according to one embodiment of the invention.

FIG. 2 shows a cleaning apparatus according to another embodiment of the invention.

FIG. 3 shows a cleaning apparatus according to a further embodiment of the invention.

FIG. 4 shows a cleaning apparatus according to yet a further embodiment of the invention.

FIG. 5 shows a cleaning apparatus according to yet another embodiment of the invention.

### DETAILED DESCRIPTION

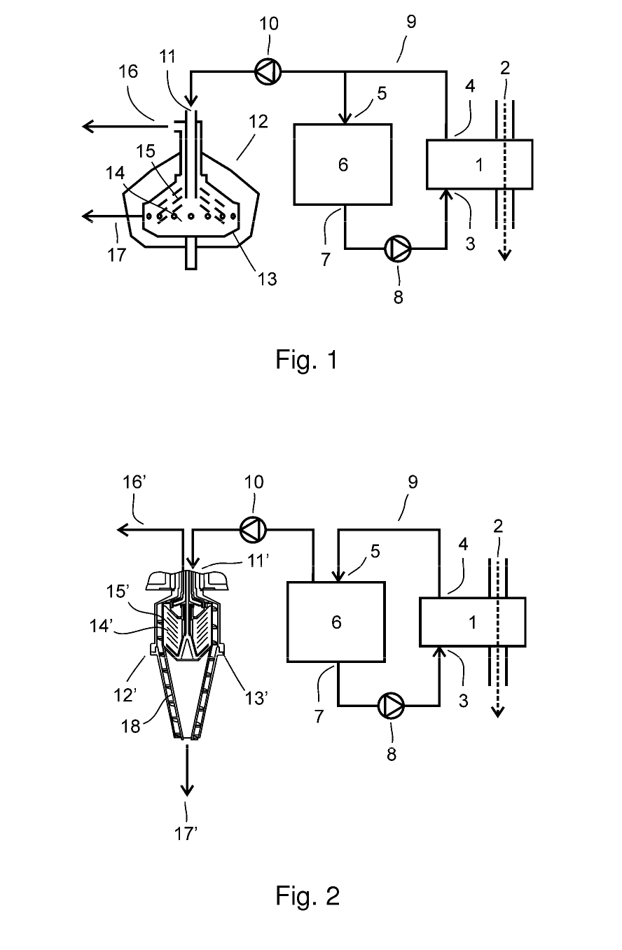

A cleaning apparatus for gas scrubber fluid is shown in FIG. 1, connected to an exhaust gas scrubber 1. The exhaust gas scrubber 1 acts on an exhaust conduit 2 of a large diesel engine, such as the main or auxiliary engine of a ship. The scrubber is provided with a scrubber inlet 3 and a scrubber outlet 4 for scrubber fluid. The scrubber outlet 4 is connected to an inlet 5 of a buffer tank 6 for scrubber fluid. The buffer tank further comprises an outlet 7 for providing scrubber fluid to the inlet 3 of the scrubber, via a scrubber feed pump 8. The scrubber 1, the buffer tank 6 and the tubing connecting them form a closed scrubber fluid loop 9 in which scrubber fluid is being circulated during operation. The scrubber fluid loop may further be provided with means for the addition of clean scrubber fluid, such as tap water, fresh water or desalinated seawater to the process during operation (not shown). This may be done in any part of the scrubber fluid loop 9.

The cleaning apparatus comprises tubing connected to the scrubber fluid loop 9 downstream of the scrubber outlet 4, for bleeding off part of the polluted scrubber fluid from the scrubber fluid loop. A separator feed pump 10 is connected to the tubing for pumping said part of the polluted scrubber fluid to the inlet 11 of a disc stack centrifugal separator 12. The feed pump may be replaced by other means for providing fluid flow to the separator inlet, such as by utilizing gravity or by means of overpressure in the buffer tank 6 or scrubber 1. The centrifugal separator 12 has a rotor 13 enclosing a separation space 14 which contains a stack of frusto-conical separating discs 15 to which separation space the separator inlet 11 extends. The centrifugal separator 12 is further provided with a first separator outlet 16 extending from a radially inner portion of the separation space for discharge of cleaned scrubber fluid, and a second outlet 17 extending from a radially outer portion of the separating space through the rotor in the form of discharge ports or nozzles for discharge of a separated phase with density higher than the cleaned scrubber fluid. The first separator outlet 16 for cleaned scrubber fluid may lead to the outside of the ship for discharge, or to a tank for temporary storage. The second separator outlet 17 may be connected to a storage tank for polluted phase.

During operation, scrubber fluid is provided from the buffer tank 6 to the scrubber inlet 3 via the scrubber feed pump 8. Scrubber fluid is atomised in the scrubber 1 and supplied to a flow of exhaust gas in or from the exhaust conduit 2. In the scrubber the scrubber fluid is used in cleaning of organic and inorganic combustion residues from the exhaust gas. The resulting mixture of scrubber fluid and exhaust gas combustion residues is separated from the gas stream in the form of droplets and is led back to the buffer tank 6 from the scrubber outlet 4 and the inlet 5 for scrubber fluid of the cleaning apparatus, thereby closing the scrubber fluid loop 9. Exhaust gas combustion residues contained in the scrubber fluid in the form of small particles are agglomerated into larger particles in the fluid, forming a pollutant phase. From the scrubber fluid loop 9, a small part of the polluted scrubber fluid is bled off and transported to the inlet 11 of the separator 12. Typically the amount of flow being bled off is below 0.2 m³/h per MW of the engine from which the exhaust gas is taken. For a 10 MW engine the amount of flow being bled off is typically below 2 m³/h. The flow of fluid in the scrubber fluid loop in such a setup is typically 400-1000 m³/h, whereby less than 1%, or even less than 1%, of the flow within the scrubber fluid loop is bled off. The scrubber fluid containing the pollutant phase is introduced into the separating space 14 with the disc stack 15, contained in the rotor 13 of the centrifugal separator 12 rotating at a high speed. The pollutant phase has a mean density that is higher than the scrubber fluid. Under the influence of centrifugal forces and facilitated by the inclined surfaces of the separating discs, the pollutant phase is separated from the scrubber fluid and collected at a radially outer portion of the separation space where from it is discharged via the second separator outlet 17. The second separator outlet 17 is in the form of discharge ports or nozzles and the particles are intermittently discharged from the centrifugal separator by opening the discharge ports at the periphery of the rotor 13 for a short period of time or continuously discharged via open nozzles at the periphery of the rotor. The discharged pollutant phase may be collected on the ship for later disposal. The concentration of pollutant particles in the discharge is within the range from about 5 to about 45 volume percent, typically from about 20 to about 30 volume percent, depending on the discharge frequency or nozzle size. The cleaned scrubber fluid is lead from the first separator outlet 16 to the outside of the ship for discharge, or to a tank for temporary storage.

In FIG. 2, another cleaning apparatus for gas scrubber fluid is shown, connected to an exhaust gas scrubber 1. The cleaning apparatus differs from what is shown in FIG. 1 in that the scrubber fluid loop is connected to a disc stack centrifugal separator 12′ for cleaning part of the scrubber fluid in the scrubber fluid loop, bled off from the buffer tank 6. The centrifugal separator 12′ has a rotor 13′ enclosing a separation space 14′ which contains a stack of frusto-conical separating discs 15′ to which separation space the separator inlet 11′ extends. The centrifugal separator 12′ is further provided with a first separator outlet 16′ extending from a radially inner portion of the separation space for cleaned scrubber fluid, and a second outlet 17′ extending from a radially outer portion of the separating space for discharge of a separated phase with density higher than the cleaned scrubber fluid. The separator is further provided with a conveyor screw 18 which is enclosed in the rotor 13′ and which is arranged to be driven at a rotational speed differing from the rotational speed of the rotor so that to convey the pollutant phase towards the second separator outlet 17′. The first separator outlet 16′ for cleaned scrubber fluid may lead to the outside of the ship for discharge, or to a tank for temporary storage. The second separator outlet 17′ may be connected to a storage tank for polluted phase.

During operation, part of the polluted scrubber fluid is bled off from the scrubber fluid loop 9, and transported to the inlet 11′ of the separator 12′. The scrubber fluid containing the pollutant phase is introduced into the separating space 14′ contained in the rotor 13′ of the centrifugal separator 12′ rotating at a high speed and further into the disc stack 15′. Typically, the disc stack is rotating at 7500 rpm, and the radius of the separating space is 93 mm, thus exerting a centrifugal force up to 5750 G during operation. The pollutant phase has a mean density that is higher than the scrubber fluid. Under the influence of centrifugal forces and facilitated by the inclined surfaces of the separating discs, the pollutant phase is separated from the scrubber fluid and collected at a radially outer region of the separation space 14′ from which it is conveyed by means of the conveyor screw 18 which is driven at a rotational speed differing from the rotational speed of the rotor. The pollutant phase is conveyed to the second separator outlet 17′, from which it is discharged. The discharged pollutant phase may be collected on the ship for later disposal. The concentration of the pollutant phase in the discharge is within the range of 20-65 weight percent. The cleaned scrubber fluid is lead from the first separator outlet 16′ to the outside of the ship for discharge, or to a tank for temporary storage.

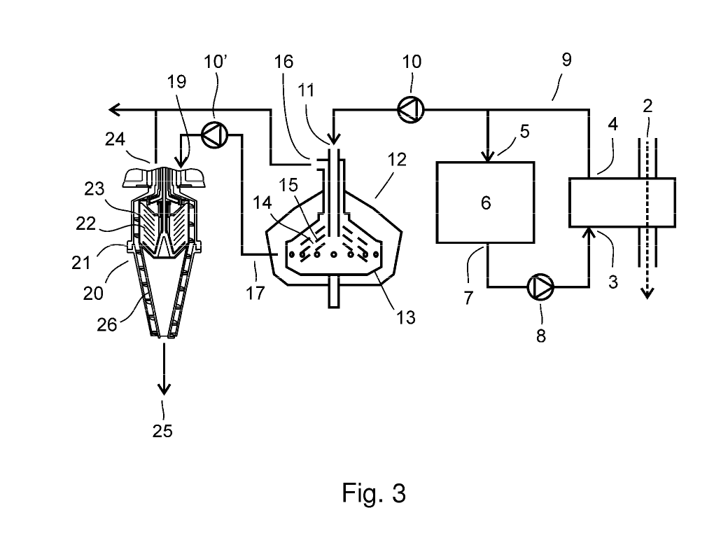

FIG. 3 shows a cleaning apparatus for exhaust gas scrubber fluid, as previously described in FIG. 1, where the second separator outlet 17 is connected to the separator inlet 19 of a further disc stack centrifugal separator 20, via a second separator feed pump 10′. The second feed pump 10′ may be replaced by other means for providing fluid flow to the separator inlet, such as by utilizing gravity, and may be connected to a buffer tank to be able to provide an even and controlled flow (not shown). The further centrifugal separator 20 has a rotor 21 enclosing a separation space 22 which contains a stack of frusto-conical separating discs 23 to which separation space the separator inlet 19 extends. The further centrifugal separator 20 is provided with a first separator outlet 24 for cleaned scrubber fluid, which is connected to the first separator outlet 16 for cleaned scrubber fluid of the separator 12. The further centrifugal separator 20 is provided with a second outlet 25 extending from the separating space for discharge of a separated phase with density higher than the cleaned scrubber fluid. The separator 20 is provided with a conveyor screw 26 which is enclosed in the rotor 21 and which is arranged to be driven at a rotational speed differing from the rotational speed of the rotor so that to convey the pollutant phase towards the second separator outlet 25.

During operation, polluted phase discharged from the separator 12 via the second separator outlet 17, is introduced into the separating space 22 of the further centrifugal separator 20 via the inlet 19. In an operation similar to what is described in FIG. 2, the pollutant phase is further concentrated by removing even more of the cleaned scrubber fluid, thereby making the pollutant phase even dryer. The pollutant phase is collected at a radially outer portion of the separation space 22 from which it is conveyed by means of the conveyor screw 26 to the second separator outlet 25. Discharged pollutant phase may be collected on the ship for later disposal. The concentration of the pollutant phase in the discharge is within the range of 20-65 weight percent. The cleaned scrubber fluid is discharged via the outlet 24 from which it is lead to the outside of the ship for discharge, or to a tank for temporary storage, separately or together with the cleaned scrubber fluid from the first separator 12.

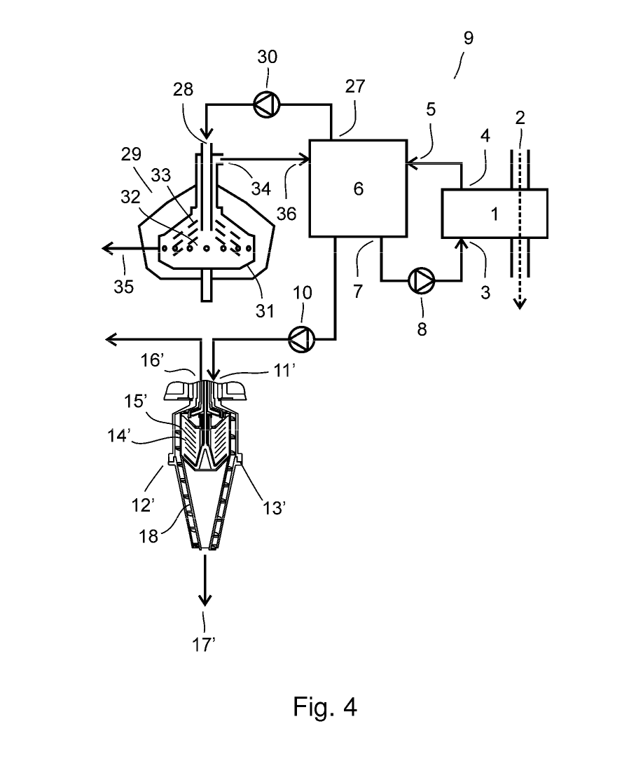

FIG. 4 shows a cleaning apparatus for exhaust gas scrubber fluid, similar to what is previously described in FIG. 2, where a disc stack centrifugal separator 12′ is arranged for cleaning polluted scrubber fluid being bled off from a scrubber fluid loop 9, in this case from the buffer tank 6. The scrubber fluid loop includes a further centrifugal separator 29 comprising a disc stack. Starting from an outlet 27 the buffer tank 6 is provided with a cleaning loop for scrubber fluid connected to a separator inlet 28 of the further centrifugal separator 29 via a separator feed pump 30. The centrifugal separator 29 has a rotor 31 enclosing a separation space 32 which contains a stack of frusto-conical separating discs 33 to which separation space the separator inlet 28 extends. The centrifugal separator 29 is further provided with a first separator outlet 34 for cleaned scrubber fluid, and a second outlet 35 extending from the separating space through the rotor in the form of discharge ports or nozzles for discharge of a separated phase with density higher than the cleaned scrubber fluid. The first separator outlet 34 is connected to an inlet 36 on the buffer tank 6, closing the cleaning loop. As an alternative, the first separator outlet may also be connected to an outlet which is lead to the outside of the ship for discharge, or to a tank for temporary storage, so that to discharge part of the cleaned scrubber fluid from the first separator outlet 34 separately or together with the cleaned scrubber fluid from the first separator 12′, similar to what is shown in FIG. 3.

The operation of the cleaning apparatus in FIG. 4 is similar to what is described in FIG. 2 with the addition of the cleaning loop. Scrubber fluid in the buffer tank 6 is, continuously or when needed, sent via the outlet 27 into the cleaning loop by means of the separator feed pump 30 to the separator inlet 28 of the centrifugal separator 29. The scrubber fluid containing the pollutant phase is introduced into the separating space 32 contained in the rotor 31 of the centrifugal separator 29 rotating at a high speed and further into the disc stack 33. The pollutant phase is separated from the scrubber fluid and collected at a radially outer region of the separation space from which it is discharged via the second separator outlet 35. The second separator outlet 35 is in the form of discharge ports or nozzles and the particles are intermittently discharged from the centrifugal separator by opening the discharge ports at the periphery of the rotor 31 for a short period of time or continuously discharged via open nozzles at the periphery of the rotor. The discharged pollutant phase may be collected on the ship for later disposal. The concentration of the pollutant phase in the discharge is within the range from about 5 to about 45 volume percent, typically from about 20 to about 30 volume percent, depending on the discharge frequency or nozzle size. The cleaned scrubber fluid is discharged from the first separator outlet 34 and sent back to the buffer tank 6.

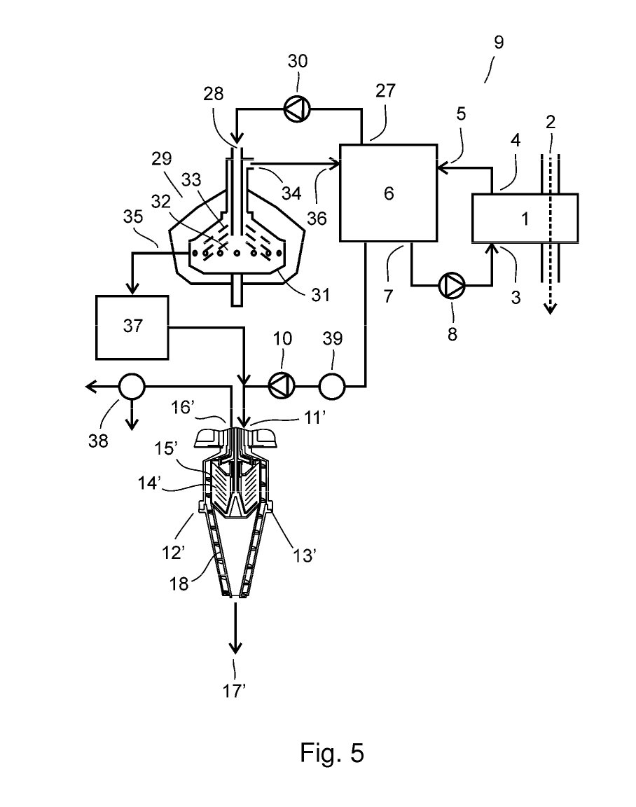

In FIG. 5, the cleaning apparatus as described in FIG. 4 is further modified by incorporating a discharge buffer tank 37 connected to the second separator outlet 35 in the cleaning loop. The buffer tank 37 is further connected to the inlet 11′ of the disc stack centrifugal separator 12′ via fluid regulating means. The fluid regulating means may comprise a feed pump or a valve in combination with gravity-driven flow. The operation of the cleaning apparatus differs from what is described in FIG. 4 in that the discharged pollutant phase from the separator 29 in the cleaning loop is introduced and further concentrated in the separator 12′. The flow of polluted fluid from the buffer tanks 6 and 37 may be individually controlled to alter or blend the flows in a suitable manner.

The cleaning apparatus shown in any of the figures may further comprise a quality control device 38 as illustrated in FIG. 5. This quality control device 38 may be included in any one of FIGS. 1-5 connected downstream of the first separator outlet 16 or 16′. The quality control device 38 is adapted to divert the flow of the cleaned scrubber fluid if the quality is lower than a certain required or predetermined quality level. The cleaned scrubber fluid may thus be diverted and/or returned to the scrubber fluid loop 9, such as to the buffer tank 6, to the separator inlet 11 or 11′ or to a separate tank (not shown). The quality control device may be adapted control the turbidity, the pH and/or the concentration of particular chemical compounds such as polyaromatic hydrocarbons. Typically the quality control device control that the turbidity of the cleaned scrubber fluid is less than 25 FNU (formazin nephlometric units), or 25 NTU (nephlometric turbidity units), above the turbidity of the fluid being entered into the system, that the acidity is above pH 6.5 at the overboard discharge with the exception that during manoeuvring and transit, the maximum difference to the fluid being entered into the system being pH 2.

The cleaning apparatus shown in any of the figures may further comprise a device 39 for the addition of a flocculant to the polluted scrubber fluid upstream of the separator inlet 11′, as illustrated in FIG. 5. Such a device 39 may be included in any one of FIGS. 1-5, and arranged upstream of any separator inlet 11, 11′ or 19 and upstream or downstream of the optional feed pump 10 or 10′. The flocculant may be a polyelectrolyte and is added in order to facilitate agglomeration of particles in the polluted scrubber fluid when needed, to improve the separation efficiency and/or separation capacity. In a similar fashion a device for the addition of a precipitant to the polluted scrubber fluid may be arranged upstream of any separator inlet 11, 11′ or 19 and upstream or downstream of the optional feed pump 10 or 10′. The precipitant is selected to add trivalent ions, such as trivalent iron or trivalent aluminium to the scrubber fluid and may be in the form of aluminium sulphate, (poly) aluminium chloride or iron chloride.

1-17. (canceled)

18. A cleaning apparatus for polluted scrubber fluid from an exhaust gas scrubber fluid loop, comprising
means for bleeding off part of the polluted scrubber fluid from the scrubber fluid loop,
a disc stack centrifugal separator for separating at least a pollutant phase and a cleaned scrubber fluid from said part of the polluted scrubber fluid, which separator comprises a rotor enclosing a separation space with a stack of separating discs, a separator inlet for said part of the polluted scrubber fluid extending into said separating space, a first separator outlet for cleaned scrubber fluid extending from said separating space, and a second separator outlet for the pollutant phase extending from said separating space, which cleaning apparatus further comprises
means for conducting said part of the polluted scrubber fluid to the separator inlet, and
means for discharging the cleaned scrubber fluid from the first separator outlet, and means for collecting the pollutant phase from the second separator outlet.

19. A cleaning apparatus according to claim 18 wherein the rotor of the separator further encloses a conveyor screw which is arranged to be driven at a rotational speed differing from the rotational speed of the rotor so that to convey the pollutant phase towards the second separator outlet.

20. A cleaning apparatus according to claim 19 wherein the separator is arranged to subject said part of the polluted scrubber fluid to a centrifugal force of at least 4000 G, preferably of at least 4500 G, more preferably of at least 5000 G during a fully developed operational speed in order to separate at least a pollutant phase and a cleaned scrubber fluid from said part of the polluted scrubber fluid.

21. A cleaning apparatus according to claim 19, wherein the separator is controlled to obtain a pollutant phase, wherein the concentration of particles is 20-65 weight percent.

22. A cleaning apparatus according to claim 18, wherein the separator inlet is of a hermetic type.

23. A cleaning apparatus according to claim 18, wherein said means for conducting said part of the polluted scrubber fluid to the separator inlet comprises a flow regulating device.

24. A cleaning apparatus according to claim 18, further comprising means for adding a flocculant to said part of the polluted scrubber fluid upstream of the separator inlet.

25. A cleaning apparatus according to claim 18, further comprising means for adding a precipitant to said part of the polluted scrubber fluid upstream of the separator inlet.

26. A cleaning apparatus according to claim 18, wherein the scrubber fluid is water, such as tap water, desalinated water, fresh water, etc.

27. A cleaning apparatus according to claim 18, wherein the cleaning apparatus comprises means for controlling the quality of the cleaned scrubber fluid, and means for diverting and/or returning the cleaned scrubber fluid to the scrubber fluid loop, to the separator inlet or to a tank for polluted scrubber fluid if the quality is below a predetermined level.

28. A cleaning apparatus according to claim 18, wherein the cleaning apparatus comprises means for bleeding off parts of the polluted scrubber fluid from more than one scrubber fluid loop and means for conducting said parts of the polluted scrubber fluid to the separator inlet.

29. A cleaning apparatus according to claim 28, wherein the means for conducting said parts of the polluted scrubber fluid to the separator inlet comprises flow regulating devices, so that to regulate the flow of the parts of the polluted scrubber fluid from each scrubber fluid loop to the separator inlet.

30. A cleaning apparatus according to claim 18, wherein the means for conducting said part of the polluted scrubber fluid to the separator inlet is arranged to receive polluted phase from a further disc stack centrifugal separator, which is arranged to separate at least a pollutant phase and a cleaned scrubber fluid from said polluted scrubber fluid in the scrubber fluid loop.

31. A cleaning apparatus according to claim 30, wherein the means for conducting said part of the polluted scrubber fluid to the separator inlet is arranged to receive polluted phase from a further disc stack centrifugal separator via a second buffer tank and a flow regulating device, preferably a pump or valve.

32. A cleaning apparatus according to claim 18, further comprising means for controlling and/or regulating the acidity of said part of the polluted scrubber fluid arranged to keep the pH within the range of 6-8.

33. An exhaust gas cleaning apparatus for a diesel engine comprising:
a gas scrubber having an inlet for exhaust gas, a humidifying device for providing a scrubber fluid to the exhaust gas and a droplet separator for removing polluted scrubber fluid from the exhaust gas and a scrubber fluid loop for circulating the scrubber fluid to the scrubber, connected to a cleaning apparatus according to claim 18.

34. A method for using a disc stack centrifugal separator comprising:
providing a cleaning apparatus including means for bleeding off part of the polluted scrubber fluid from the scrubber fluid loop, a disc stack centrifugal separator for separating at least a pollutant phase and a cleaned scrubber fluid from said part of the polluted scrubber fluid, which separator comprises a rotor enclosing a separation space with a stack of separating discs, a separator inlet for said part of the polluted scrubber fluid extending into said separating space, a first separator outlet for cleaned scrubber fluid extending from said separating space, and a second separator outlet for the pollutant phase extending from said separating space, which cleaning apparatus further comprises means for conducting said part of the polluted scrubber fluid to the separator inlet, and means for discharging the cleaned scrubber fluid from the first separator outlet, and means for collecting the pollutant phase from the second separator outlet;
separating at least the pollutant phase and the cleaned scrubber fluid from the polluted scrubber fluid being bled off from an exhaust gas scrubber fluid loop.
